(19) United States
(12) Patent Application Publication
(10) Pub. No.: US 2005/0068504 A1
(43) Pub. Date: Mar. 31, 2005

(54) Device for homogeneous, multi-color illumination of a surface

(76) Inventors: Arne Trollsch, Grossschwabhausen (DE); Uwe Detlef Zeitner, Weimar (DE); Peter Schreiber, Jena (DE); Ralf Waldhausl, Jena (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/954,635

(22) Filed: Sep. 30, 2004

(30) Foreign Application Priority Data
Sep. 30, 2003 (DE) 103 45 431.4

(51) Int. Cl. G03B 21/00

(52) U.S. Cl. 353/31

(57) ABSTRACT

A device for homogeneous, multi-color illumination of a surface includes first and second light sources emitting light of different colors, a combining unit directing the light from the light sources into a common beam path, and including a condenser system having one first lens array each between the combining unit and each light source and an optical unit having positive refractive power in the common beam path.

### FIELD OF THE INVENTION

The invention relates to a device for homogeneous, multi-color illumination of a surface. Such illumination devices are often employed in projectors comprising two-dimensional light modulators, in order to enable multi-color illumination of the two-dimensional light modulator as homogeneously as possible.

### BACKGROUND OF THE INVENTION

Known illumination devices for projectors often use white-light sources, whose white light first needs to be split up into at least three primary colors for color modulation. This leads to relatively complex optical systems.

In view thereof, it is an object of the invention to provide a device for homogeneous, multi-color illumination of a surface which can have an extremely compact design.

### SUMMARY OF THE INVENTION

According to the invention, the object is achieved by a device for homogeneous, multi-color illumination of a surface, comprising first and second light sources emitting light of different colors, a combining unit directing the light from the light sources into a common beam path, and comprising a condenser system having one first lens array each between the combining unit and each light source and an optical unit having positive refractive power in the common beam path.

Using this arrangement, the combining unit required in order to superimpose the light from the light sources is advantageously arranged within the condenser system, namely between the optical unit, on the one hand, and the lens arrays, on the other hand. Thus, the space to be provided for the condenser system is virtually filled completely by a further optical unit, i.e. the combining unit, so that the device as a whole is very compact. Thus, the desired compact design of the device is achieved, while at the same time achieving an extremely homogeneous illumination due to the condenser system comprising said lens array and said optical unit.

A preferred embodiment of the device according to the invention consists in that the optical distance from the optical unit to the surface to be illuminated and to the first lens arrays respectively corresponds to the focal length of the optical unit. Therefore, the condenser system corresponds to a honeycombed condenser system having a telecentric beam path on the image-side and etendue conservation.

A further embodiment of the projection device according to the invention consists in that the condenser system comprises, between the first lens array and the corresponding light source, a second lens array, with the focal points of the lenses of the second lens array preferably being located in the plane of the first lens array. The use of two lens arrays arranged following each other makes it particularly easy to adjust the homogenization to a determined aspect ratio of the surface to be illuminated, in particular if said surface is rectangular. Thus, for example, use can be made of two cylinder lens arrays which are rotated 90° relative to each other, so that the desired rectangular aspect ratio is easily adjustable. This is also particularly advantageous insofar as cylinder lens arrays are easy to manufacture.

The two lens arrays arranged following each other may be provided as a tandem lens array, wherein the lens arrays are arranged on the front and rear surfaces of a substrate. Thus, a very compact optical element is provided allowing the entire illumination device to have a compact design. The two lens arrays are preferably equal in design and adjusted relative to each other.

Instead of two cylinder lens arrays, use may also be made of one single lens array, wherein the lenses are arranged in rows and columns, thus reducing the number of the array. Such lens array may be provided such that it has the same optical effect as two cylinder lens arrays arranged following each other, which are preferably rotated 90° relative to each other, and it may, of course, be further embodied as a tandem lens array, too.

It is further possible to provide an additional tandem lens array between the tandem lens array and the respective light source. In this case, both tandem lens arrays may be provided as tandem cylinder lens arrays which are rotated relative to each other. Different lens parameters of the cylinder lens arrays of the two tandem cylinder arrays enable an optimal adjustment to the surface to be illuminated (in particular, if said surface is rectangular).

It is particularly preferred if the light sources in the device according to the invention comprise at least one light emitting diode. Light emitting diodes are nowadays available in the primary colors, red, green and blue, and have excellent durability and very good electrooptical efficiency. Thus, the illumination device as a whole can have a compact design which saves electrical energy.

If a light emitting diode is employed for each light source, collimator optics preferably comprising an aspheric lens can be arranged between the light emitting diode and the first lens array. Thus, a very well-collimated beam is generated. Further, an etendue-maintaining collimation can be achieved by means of said collimator optics.

Furthermore, the optical unit may comprise a lens provided as a Fresnel lens or may consist only of a Fresnel lens. This has the advantage that the space between the lens and the combining unit increases without increasing the dimensions of the device as a whole.

It is further particularly preferred that the optical unit in the projection device according to the invention may be provided as an aspheric lens. Thus, the required imaging properties can be realized by means of just one single lens.

Further, a third light source (which preferably also comprises a light emitting diode) may also be provided, whose light is directed into the common beam path by means of the combining unit. Thus, three light sources, which preferably emit light of the primary colors red, green and blue, can be used for homogeneous, multi-color illumination of the surface to be illuminated.

The light sources may each comprise a single light emitting diode or also several light emitting diodes which are arranged as an array.

The third light source preferably has a second combining unit arranged following it, which directs the light from the second and third light sources into a beam path extending from the second combining unit to the first combining unit, said beam path having one of the first microlens arrays arranged therein as a common microlens array for the second and third light sources. Thus, a very compact illumination device can be provided, wherein only one microlens array needs to be provided for two of the light sources. This reduces the number of optical elements, so that the device can be manufactured with a reduced weight and at reduced cost.

The second combining unit and/or the first combining unit can be realized as a wire grid polarizer or generally as a polarizing beam splitter. Such wire grid polarizers are nowadays standard optical elements, which are commercially available.

Further, the illumination device can also be embodied such that the condenser system comprises a first lens array between the third light source and the combining unit. In this case, it is possible to direct the light from three light sources into the common beam path by means of just one single combining unit. This leads to an extremely compact arrangement.

The combining unit is preferably provided as a so-called X cube, which comprises two crossed color-splitting layers, preferably extending at an angle of 90° relative to each other, by which the light from two of the three light sources is reflected and the light from the third light source is transmitted.

Further, a projection device is also provided, which comprises the above-described device for homogeneous, multi-color illumination and further comprises a light modulator, a control unit controlling the light modulator on the basis of given image data, and projection optics for projecting an image generated by means of the light modulator onto a projection surface, wherein the image-generating region of the light modulator is the surface to be illuminated, or the surface to be illuminated is imaged onto the image-generating region by means of further optics of the projection device.

This projection device can have a very compact and small design due to the illumination device.

Particularly preferably, a polarizing beam splitter is arranged, in addition, between the optical unit and the light modulator. In this case, the light modulator is preferably a polarization-sensitive, reflective light modulator. The entire projection device is then very compact, because the space between the optical unit and the surface to be illuminated (light modulator) present in the condenser system is directly used to separate on-light (light for pixels to be displayed as bright pixels) and out-light (light for pixels to be displayed as dark pixels) by means of the polarizing beam splitter.

As the light modulator, transmissive or reflective light modulators, such as LCD or LCoS modules or even tilting mirror matrices, may be employed. The multi-color display can be effected sequentially in time by means of one single light modulator, such that the light modulator is sequentially illuminated with the light from the light sources. There may also be provided a plurality of light modulators, which are simultaneously illuminated with light of different colors, wherein the modulated light beams emitted by the light modulators are then superimposed by means of suitable optics and then projected by means of the projection optics.

### BRIEF DESCRIPTION OF THE DRAWINGS

The invention will be explained in more detail below, by way of example, with reference to the Figures, wherein:

FIG. 1 shows a first embodiment of the illumination device according to the invention;

FIG. 2 shows a schematic representation of the condenser system used in FIG. 1, and

FIG. 3 shows a projection device comprising an illumination device according to a second embodiment.

### DETAILED DESCRIPTION OF THE INVENTION

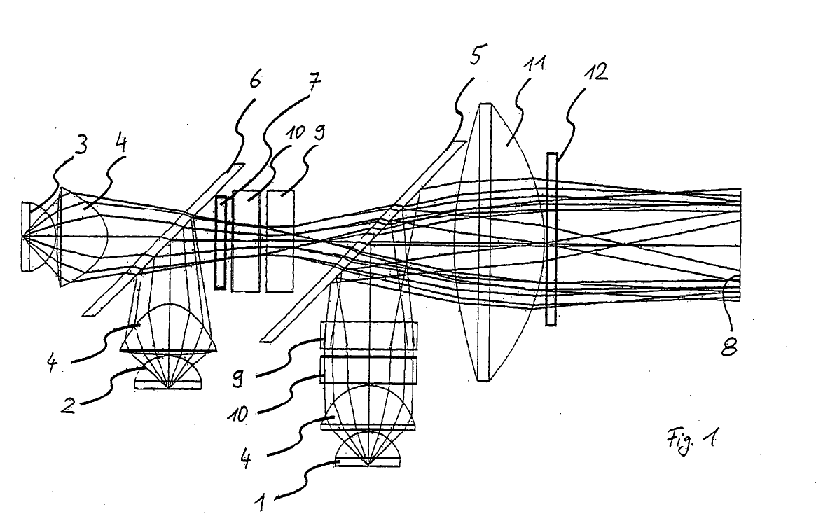

The illumination device shown in FIG. 1 comprises a light emitting diode 1 emitting green light, a light emitting diode 2 emitting red light and a light emitting diode 3 emitting blue light, which respectively come close to having Lambert emission characteristics. Each of the three light emitting diodes 1-3 has a respective aspheric lens 41, 42, 43 arranged following it to collimate the light from the light emitting diodes.

The lenses 41, 42, 43 consist of polycarbonate and have the following geometric parameters:

| | Center | | | | | | | | | |
|---|---|---|---|---|---|---|---|---|---|---|
| | thickness | Diameter | R1 | | a₄_{_{—}}1 | a₆_{_{—}}1 | R2 | | a₄_{_{—}}2 | a₆_{_{—}}2 |
| Lens | [mm] | [mm] | [mm] | k1 | [mm⁻³] | [mm⁻⁵] | [mm] | k2 | [mm⁻³] | [mm⁻⁵] |
| 42 | 4 | 7.8 | 31.7208 | 1.6804 | 0 | 0 | −2.3178 | −0.8702 | 0 | 0 |
| 43 | 4 | 7.8 | 31.7208 | 1.6804 | 0 | 0 | −2.3178 | −0.8702 | 0 | 0 |
| 41 | 3.5 | 7.8 | −181.77 | 0 | −9.64e−4 | 4.6e−5 | −3.7087 | −0.4386 | −1.49e−3 | −7.9e−5 |

In this Table, R1 and R2 designate the radius of curvature R of the corresponding first and second surfaces F1, F2; k1 and k2 are the respective conical constant k; and a₄_{_{—}}₁, a₄_{_{—}}₂ and a₆_{_{—}}₁, a₆_{_{—}}₂ are the 4^{th} and 6^{th} order surface terms a₄ and a₆ of the first and second surfaces F1 and F2 according to the following formula (1) for the profile height z:

$$z = \frac{c \cdot {r}^{2}}{1 + \sqrt{1 - ( 1 + k ) \cdot {c}^{2} \cdot {r}^{2}}} + {a}_{4} \cdot {r}^{4} + {a}_{6} \cdot {r}^{6} + … \qquad ( 1 )$$

wherein

$$c = \frac{1}{R} ;$$

surface coordinates (x, y, z) and r²=x²+y².

The illumination device further comprises first and second combining units 5, 6, with the second combining unit 6 being provided as a wire grid polarizer which deflects the s-polarized red light 90° to the right and transmits the p-polarized blue light, so that red s-polarized light and blue p-polarized light passes along a beam path which extends from the second combining unit 6 to the first combining unit 5.

Since the first combining unit 5 is also provided as a wire grid polarizer, which reflects the s-polarization of the light and transmits p-polarization, the color red still needs to be put in the condition of p-polarization after superposition by means of the second combining unit 6. As this is already the case for the blue light, a color-selective retarder 7 is provided, which rotates the polarization of the light in the red spectral range around 90°, so that also the red light is p-polarized. Thus, the red and blue light respectively impinge on the first combining unit 5 with p-polarization and are transmitted. In contrast thereto, the s-polarized green light from the light emitting diode 1 is reflected 90° to the right by the first combining unit 5, so that all three colors are superimposed on each other behind the first combining unit 5 and impinge on a surface 8 to be illuminated.

Between the first and second combining units 5 and 6 as well as between the first light source 1 and the first combining unit 5, there are respectively arranged two so-called tandem lens arrays 9, 10, which, together with a focussing lens 11 arranged following the first combining unit 5, form a honeycombed condenser system using which the surface 8 to be illuminated is illuminated in a homogeneous manner.

Tandem lens arrays 9, 10 as used herein means that on the front and rear surfaces of a substrate one lens array 91, 92; 101, 102 each is arranged, which are identical in this case and adjusted relative to each other. The substrate thicknesses of both tandem lens arrays 9, 10 are selected such that the focal points of the lenses of the respective lens array 91, 101 on the front surface are located in the principal plane of the lenses of the respective lens array 92, 102 on the rear surface of the substrate. The lens arrays 9 and 10 are embodied as two crossed tandem cylinder lens arrays and are adapted to the surface 8 to be illuminated, which corresponds to 11 mm×8.5 mm in this case.

The tandem lens arrays 9, 10 are characterized by the following Table 2.

| | Surface | | Center | | | |
|---|---|---|---|---|---|---|
| Lens | (w × h) | Lens | Thickness | Refractive | | |
| array | [mm²] | width [mm] | [mm] | index | R [mm] | k |
| 9 | 8 × 10 | 0.9 | 2.28 | 1.5 | 0.8639 | −0.7726 |
| 10 | 8 × 10 | 0.7 | 2.28 | 1.5 | 0.8639 | −0.7726 |

The center thickness is the distance between the vertices of the opposite lenses of both lens arrays of a tandem lens array. The profile height z of the individual lens array 91, 92, 101, 102 is then as follows:

$$z = \frac{{c}_{x} \cdot {x}^{2} + {c}_{y} {y}^{2}}{1 + \sqrt{1 - ( 1 + {k}_{x} ) {c}_{x}^{2} \cdot {x}^{2} - ( 1 - {k}_{y} ) \cdot {c}_{y}^{2} \cdot {y}^{2}}} ,$$

wherein

$${c}_{x} = \frac{1}{{R}_{x}} ; {c}_{y} = \frac{1}{{R}_{y}} ,$$

surface coordinates (x, y, z).

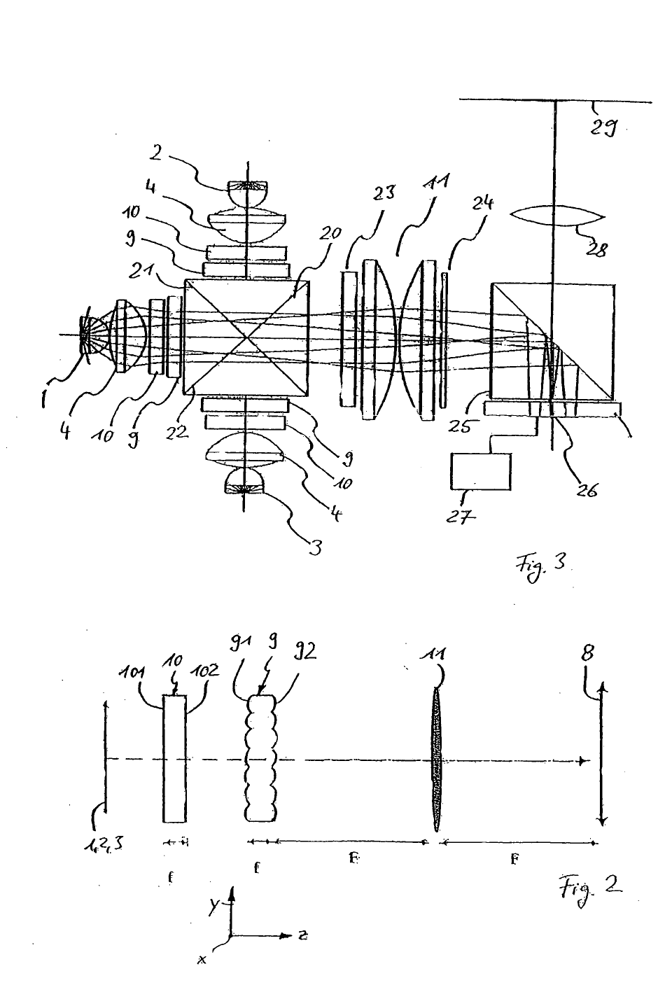

In the tandem lens arrays described here, the cylinder lenses of the lens arrays 91, 92 extend in the x direction (perpendicular to the drawing plane in FIG. 2), so that, in this case, Cₓ=0. The cylinder lenses of the lens arrays 101, 102 extend in the y direction, so that, in this case, c_{y}=0.

The focussing lens 11 has a focal length F, wherein the optical distance from the focussing lens 11 to the first lens array 9 corresponds to the focal length F and the surface 8 to be illuminated is also spaced apart from the focussing lens 11 by the focal length F. The focussing lens 11 is made of PMMA and has a diameter of 22 mm for a center thickness of 7.5 mm. The radiuses of curvature of the surfaces F3 and F4 are −20.785 mm and 13.888 mm. The conical constants k1 and k2 are −9.00766 and −0.8782. The focal length F of the focussing lens 11 is 16 mm. The profile height is obtained according to formula (1), wherein only terms up to the square terms of r are considered.

Further, the illumination device additionally comprises a color-selective retarder 12, which only rotates the polarization in the green spectral range around 90°, so that the surface 8 to be illuminated is illuminated with red, green and blue light having the same polarization. This is required, in particular, when using polarization-sensitive image generators (e.g. image generators on the basis of liquid crystals). Of course, the retarder 12 may also be arranged between the focussing lens 11 and the first combining unit 5. Likewise, the retarder 7 may also be arranged at any location between the first and second combining units 5 and 6.

FIG. 2 again shows the optical principle of the condenser system used. The lens arrays 91 and 92 as well as 101 and 102 of the two tandem lens arrays 9, 10 are respectively spaced apart by the focal length f of the lenses of the lens arrays 91, 92 and 101, 102, respectively, and the optical distance from the lens array 92 of the first tandem lens array 9 to the focussing lens 11 and from the focussing lens 11 to the surface 8 to be illuminated is in each case the focal length F of the focussing lens 11.

In the surface 8 to be illuminated a transmissive light modulator may be arranged, for example.

FIG. 3 shows a projection device comprising an illumination device according to a second embodiment, wherein the same elements are referred to by the same reference numerals and their description is not repeated. In contrast to the embodiment shown in FIG. 1, only one color combining unit is provided in FIG. 3 in the form of a so-called X cube 20, which comprises two color-splitting layers 21 and 22 crossing each other and extending at an angle of 90° relative to each other. The color-splitting layers 21 and 22 are dielectric layers, with the color-splitting layer 21 being formed of HfO₂-, Al₂O₃-, TiO₂-layers and the color-splitting layer 22 being formed of TiO₂- and SiO₂-layers and preferably reflecting light having s-polarization, so that, behind the X cube 20, the blue and red light are substantially s-polarized and the transmitted green light is substantially p-polarized. Therefore, a color-selective λ/2-retarder 23 is provided which rotates the polarization of the green light around 90°.

In the presently described embodiment, the focussing lens 11 is provided as a two-lens system following which a pre-polarizer 24 is arranged, which absorbs or reflects light having p-polarization, so that only s-polarized light should be present behind the pre-polarizer. The polarizing beam splitter 25 then directs said light onto an LCoS modulator 26 (in a downward direction, as seen in FIG. 3), which rotates or does not rotate the direction of polarization of the incident light around 90° as a function of the given data, so as to generate a modulated beam or an image, respectively, which can be projected onto a projection surface 29 by means of projection optics 28.

Therefore, the polarizing splitter cube splits off the out-light (light of the pixels to be displayed as dark pixels) from the light reflected by the LCoS modulator so that it is reflected away to the left, as seen in FIG. 3, whereas the on-light (light of the pixels to be displayed as bright pixels) is transmitted and impinges on the projection surface 29 via the projection optics 28. Thus, the polarizing splitter cube 25 also serves as analyzer. Since the polarizing splitter cube 25 is arranged between the focussing lens 11 and the light modulator in a space which is present due to the honeycombed condenser system and even has to be provided, the projection device as a whole can be designed in a very compact manner.

In the projection device described here, the light modulator 26 is illuminated sequentially in time with red, green and blue light, so that red, green and blue partial images are sequentially projected. The change between the individual partial images is effected so quickly that a viewer can only perceive the superimposed condition of the partial color images and, thus, a multi-colored image. A control unit 27 is provided to control the light modulator 26 as well as the light sources 1 to 3.

The present invention may be embodied in other specific forms without departing from the spirit of any of the essential attributes thereof; therefore, the illustrated embodiments should be considered in all respects as illustrative and not restrictive, reference being made to the appended claims rather than to the foregoing description to indicate the scope of the invention.

1. A device for homogeneous, multi-color illumination of a surface, comprising:
first and second light sources emitting light of different colors;
a combining unit directing the light from the light sources into a common beam path;
a condenser system having one first lens array each between the combining unit and each light source; and
an optical unit having positive refractive power in the common beam path.

2. The device as claimed in claim 1, wherein an optical distance from the optical unit to the surface to be illuminated and from the optical unit to the first lens arrays respectively corresponds to the focal length of the optical unit.

3. The device as claimed in claim 1, wherein the condenser system comprises second lens arrays between each first lens array and the respective first and second light source.

4. The device as claimed in claim 3, wherein the focal points of the lenses of the second lens arrays are located in a plane of the first lens array.

5. The device as claimed in claim 3, wherein the first lens arrays and the second lens arrays lens arrays are provided as a first tandem lens arrays.

6. The device as claimed in claim 5, wherein the condenser system comprises a second tandem lens array between each first tandem lens array and the respective light source.

7. The device as claimed in claim 1, wherein at least one lens array is provided as a cylinder lens array.

8. The device as claimed in claim 1, wherein the light sources comprise at least one light emitting diode.

9. The device as claimed in claim 8, further comprising collimator optics are arranged between the light emitting diode and the lens array.

10. The device as claimed in claim 9, wherein the collimator optics comprise an aspheric lens.

11. The device as claimed in claim 1, wherein the optical unit comprises a Fresnel lens.

12. The device as claimed in claim 1, wherein the optical unit comprises an aspheric lens.

13. The device as claimed in claim 1, further comprising a third light source, whose light is directed into the common beam path by means of the combining unit.

14. The device as claimed in claim 13, further comprising a second combining unit arranged following the third light source that directs the light from the second and third light sources into a second beam path extending from the second combining unit to the first combining unit, and further comprising a first microlens array arranged as a common microlens array for the second and third light sources in the second beam path.

15. The device as claimed in claim 14, wherein the second combining unit comprises a wire grid polarizing beam splitter.

16. The device as claimed in claim 12, wherein the condenser system comprises a first lens array between the third light source and the combining unit.

17. A projector comprising a device for homogeneous, multi-color illumination, the device comprising:
first and second light sources emitting light of different colors;
a combining unit directing the light from the light sources into a common beam path;
a condenser system having one first lens array each between the combining unit and each light source;
and an optical unit having positive refractive power in the common beam path;
the projector comprising:
a light modulator;
a control unit controlling the light modulator on the basis of given image data;
and projection optics for projecting an image generated by the light modulator onto a projection surface, and wherein the image-generating region of the light modulator is the surface to be illuminated, or the surface to be illuminated is imaged onto the image-generating region.

18. The projector as claimed in claim 17, further comprising a polarizing beam splitter arranged between the optical unit and the surface to be illuminated.

19. A method of providing homogeneous, multicolor illumination to a surface, the method comprising the steps of:
directing a first beam of light from a first light source and a second beam of light from a second light source of two different colors toward a combining unit to combine the first and second beams into a common beam path;
interposing a condenser system between the first light source and the combining unit and between the second light source and the combining unit, the condenser system comprising a pair of first lens arrays each located between the combining unit and one of the first and second light sources; and
placing an optical element having a positive refractive power in the common beam path.

20. The method as claimed in claim 19, further comprising the step of placing the surface an optical distance from the optical element equal to a focal length of the optical element; and placing the first lens arrays an optical distance from the optical element equal to the focal length of the optical element

21. The method as claimed in claim 19, further comprising the step of placing into the condenser system a second lens array between each of the first lens arrays and each respective first and second light source.

22. The method as claimed in claim 21, further comprising the step of positioning focal points of the second lens arrays in a plane of the first lens arrays.

23. The method as claimed in claim 21, further comprising the step of providing the first and second lens arrays as a first tandem lens array.

24. The method as claimed in claim 23, further comprising the step of interposing a second tandem lens array between the first tandem lens array and each respective first and second light source.

25. The method as claimed in claim 19, further comprising the step of selecting a cylindrical lens for at least one lens array.

26. The method as claimed in claim 19, further comprising the step of utilizing a light emitting diode for at least one of the light sources.

27. The method as claimed in claim 26, further comprising the step of introducing collimator optics between the light emitting diode and one of the first lens arrays.

28. The method as claimed in claim 27, further comprising the step of utilizing an aspheric lens in the collimator optics.

29. The method as claimed in claim 19, further comprising the step of utilizing an optical element comprising a Fresnel lens.

30. The method as claimed in claim 19, further comprising the step of utilizing a third light source, whose light is directed into the common beam path by means of the combining unit.

31. The method as claimed in claim 30, further comprising the steps of utilizing a second combining unit arranged following the third light source: directing light from the second and third light sources into a second beam path extending from the second combining unit to the first combining unit; and introducing a first microlens arrays into the second beam path as a common microlens array for the second and third light sources.

32. The device as claimed in claim 31, further comprising the step of utilizing a polarizing beam splitter as the second combining unit

33. The device as claimed in claim 31, further comprising the step of utilizing a wire grid polarizer as the second combining unit.

34. The device as claimed in claim 31, further comprising the step of utilizing an additional first lens array between the third light source and the combining unit.
